(19) United States
(12) Patent Application Publication
(10) Pub. No.: US 2009/0245813 A1
(43) Pub. Date: Oct. 1, 2009

(54) Modulator driver with multi-channel active alignment

(75) Inventor: Andrew John Bonthron, Los Angeles, CA (US)

Correspondence Address: Kitel Technologies LLC, 2130 Linda Flora Drive, Los Angeles, CA, 90077, US

(73) Assignee: Kitel Technologies LLC, Los Angeles, CA (US)

(21) Appl. No.: 12/383,914

(22) Filed: Mar. 30, 2009

Related U.S. Application Data
(60) Provisional application No. 61/072,522, filed on Mar. 31, 2008.

(51) Int. Cl. H04B 10/04

(52) U.S. Cl. 398/188

(57) ABSTRACT

Modulator driver for driving an electro-optical modulator in a high-speed optical communications system. In accordance with aspects of the present invention, a modulator driver is presented comprising an active signal splitter providing a first pair and a second pair of differential output signals, each pair of differential output signals input to a separate variable delay circuit, each variable delay circuit in turn feeding an output buffer, whereby one signal from each output buffer is used as an output drive signal, and the other signal from each output buffer is input to a phase processor which is used to actively control said variable delay circuits, whereby the circuit architecture is compatible with compact, monolithic fabrication requiring a minimal amount of external components for operation. Other methods and apparatus are presented.

### CROSS-REFERENCE TO RELATED APPLICATIONS

This application claims the benefit of U.S. Provisional Application No. 61/072,522, filed Mar. 31, 2008 by the present inventor, which is incorporated herein by reference.

### FIELD OF THE INVENTION

The subject matter disclosed generally relates to the field of digital communications devices. More specifically, the subject matter disclosed relates to electronic arrangements for high speed, electro-optical data transmission applications.

### BACKGROUND OF THE INVENTION

An important element in high-speed fiber-optic transmission systems is the ability to optically encode data bits for transport in optical fiber media. One way this is achieved is through the modulation of the output of a continuous-wave laser source by an electro-optical modulator, whose output is coupled to an optical fiber for transmission. Many applications require high quality optical modulation performance, which imposes amplitude and signal quality requirements on the drive electronics, often referred to as a modulator driver, required to interface with the electro-optical modulator. Additionally, as optical network data rates increase, many applications require the electrical modulator driver to maintain the appropriate signal requirements for achieving high quality optical modulation performance at higher data rates.

FIG. 1 illustrates the top view of typical electro-optical modulator integrated circuit known in the art which is capable of providing modulation of an optical signal, based on a Mach-Zehnder interferometer technique with differential electrical drive inputs. A continuous-wave optical signal is input to an optical waveguide 12 where it is split into two paths. Differential electrical data signals from a modulator driver are input to the complimentary RF IN ports and travel along electrical transmission lines 14, 15 creating electric field distributions having opposite polarities in each of the optical waveguides, producing a change in the phase in each of the optical waveguides that has opposite direction. With a sufficiently large differential electrical signal amplitude, typically 4 to 8 volts peak-to-peak differential, the phase shifts induced in the optical waveguide paths, when combined, will cause the optical output signal to be modulated.

The differential drive technique of electro-optical modulation has one disadvantage of typically requiring skew adjustment between the differential drive signals to compensate for differences in the phase length of each signal path between the modulator driver circuit and the electro-optical modulator circuit, due to manufacturing and interconnect tolerances or physical asymmetries that can occur in typical implementations. A typical method used to overcome this difficulty includes the use of optical feedback control loop circuitry which can add to transmitter complexity, cost, and size.

FIG. 2 illustrates a typical differential drive modulator driver architecture known in the art which is capable of generating differential signals with sufficient amplitude to drive an electro-optical modulator such as that shown in FIG. 1. A differential input buffer 60 provides signal gain and presents signals to a differential output buffer 70, which provides gain and generates differential output signals with enough amplitude to drive an electro-optical modulator. However, this architecture has limitations in that it does not provide a means to separately adjust the skew between the output signals, nor does it provide a means to monitor or align the skew of the output signals.

Accordingly, it would be desirable to have a multiple output modulator driver architecture capable of providing adjustment and active alignment of the skew between multiple outputs. In addition, it would be desirable to have a multiple output modulator driver architecture capable of providing independent adjustment and active monitoring of the amplitude of multiple outputs. Furthermore, it would be desirable to have a multiple output modulator driver architecture compatible with compact, monolithic process fabrication techniques with a minimum of external components required for operation. Finally, it would be desirable to have a multiple output modulator driver architecture with common-mode delay adjustment capability which can be used to simplify implementation of complex optical modulation transmission techniques requiring multiple electro-optical modulator stages, such as carrier-suppressed return-to-zero (CS-RZ) or return-to-zero differential quadrature phase-shift-keying (RZ-DQPSK).

### SUMMARY OF THE INVENTION

Modulator driver for driving an electro-optical modulator in a high-speed optical communications system. In accordance with aspects of the present invention, a modulator driver is presented comprising an active signal splitter providing a first pair and a second pair of differential output signals, each pair of differential output signals input to a separate variable delay circuit, each variable delay circuit in turn feeding an output buffer, whereby one signal from each output buffer is used as an output drive signal, and the other signal from each output buffer is input to a phase processor which is used to actively control said variable delay circuits, whereby the circuit architecture is compatible with compact, monolithic fabrication requiring a minimal amount of external components for operation. Other methods and apparatus are presented.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1 is a diagram of a known electro-optical modulator architecture with a differential electrical drive port structure.

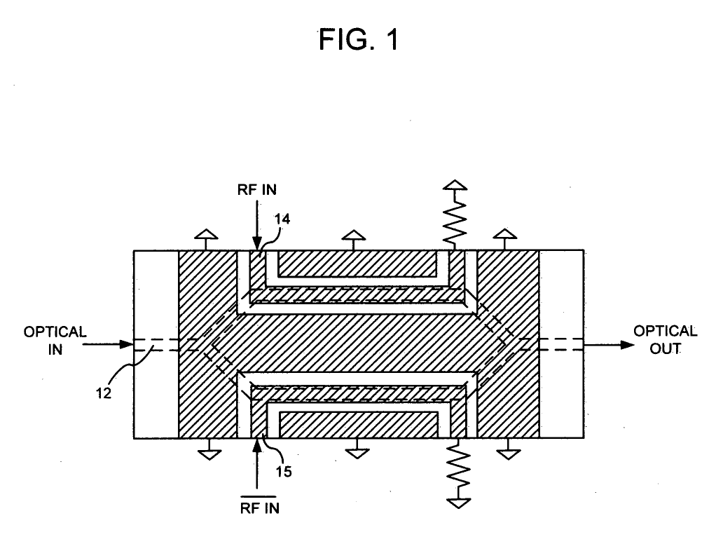

FIG. 2 is a block diagram of a known differential output modulator driver architecture.

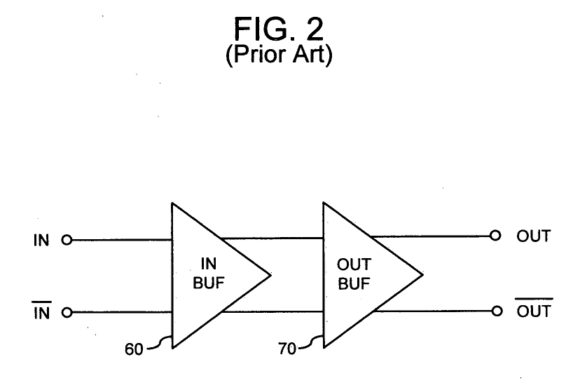

FIG. 3 is a block diagram illustrating one modulator driver arrangement for use with an electro-optical modulator according to aspects of the present invention.

FIG. 4 is a block diagram illustrating another modulator driver arrangement for use with an electro-optical modulator according to aspects of the present invention.

FIG. 5 is a block diagram illustrating features of one embodiment of a variable delay according to aspects of the present invention.

FIG. 6 is a schematic illustrating features of one embodiment of a buffer according to aspects of the present invention.

FIG. 7 is a schematic illustrating features of another embodiment of a buffer according to aspects of the present invention.

FIG. 8 is a schematic illustrating features of one embodiment of a signal splitter according to aspects of the present invention.

FIG. 9 is a schematic illustrating features of one embodiment of a phase processor according to aspects of the present invention.

### DETAILED DESCRIPTION OF THE INVENTION

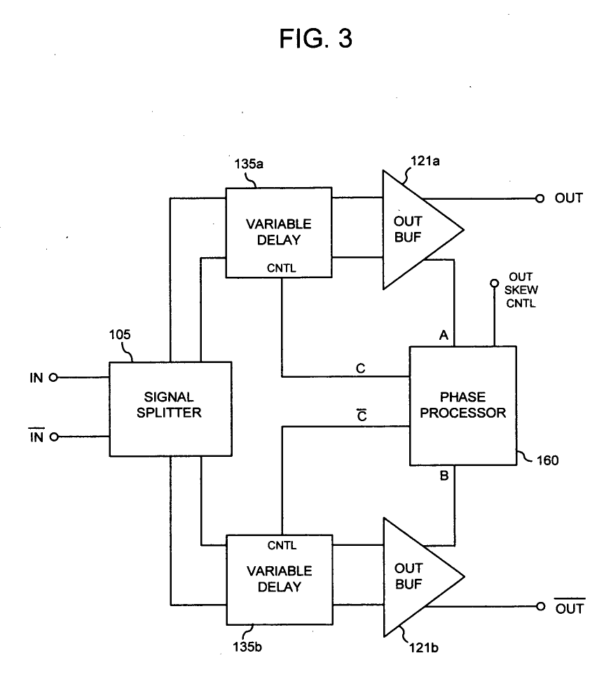

A modulator driver arrangement is presented in FIG. 3 as one embodiment of aspects of the present invention. In this arrangement, an input signal is coupled to a signal splitter 105 which provides a plurality of differential output signals derived from the input signal. The signal splitter 105 has the ability to accept differential input signals as illustrated in FIG. 3, or a single-ended input signal coupled to one input of the signal splitter 105 through a DC blocking capacitor, with the signal splitter 105 further providing a single-ended to differential signal conversion function. One output differential signal from signal splitter 105 is coupled to variable delay 135a which provides a delayed differential signal to differential output buffer 121a, while the other output differential signal from signal splitter 105 is coupled to variable delay 135b which provides a separately delayed differential signal to differential output buffer 121b. One of the outputs of differential output buffer 121a is utilized as one output drive signal, while the other output of differential output buffer 121a is coupled to one input of phase processor 160. One of the outputs of differential output buffer 121b is utilized as a second output drive signal, while the other output of differential output buffer 121b is coupled to a second input of phase processor 160. In a preferred embodiment, the output drive signals are complimentary signals of sufficient amplitude to drive a differential drive electro-optical modulator. The phase processor 160 compares the phase, or skew, between signals presented to its input each having a defined phase relationship with a corresponding output drive signal, and provides output control signals to variable delays 135a, 135b forming a control loop, where the amount and direction of the skew between the output drive signals is controlled by a skew control input (OUT SKEW CNTL). Through the use of this modulator driver arrangement, the phase relationship, or skew, between multiple output drive signals is controlled and stabilized using a simple electrical feedback control loop, which eliminates the need for complex, bulky, and expensive optical feedback control loops. In addition, this architecture is compatible with compact, monolithic fabrication of the modulator driver requiring only a minimum of external components for proper operation.

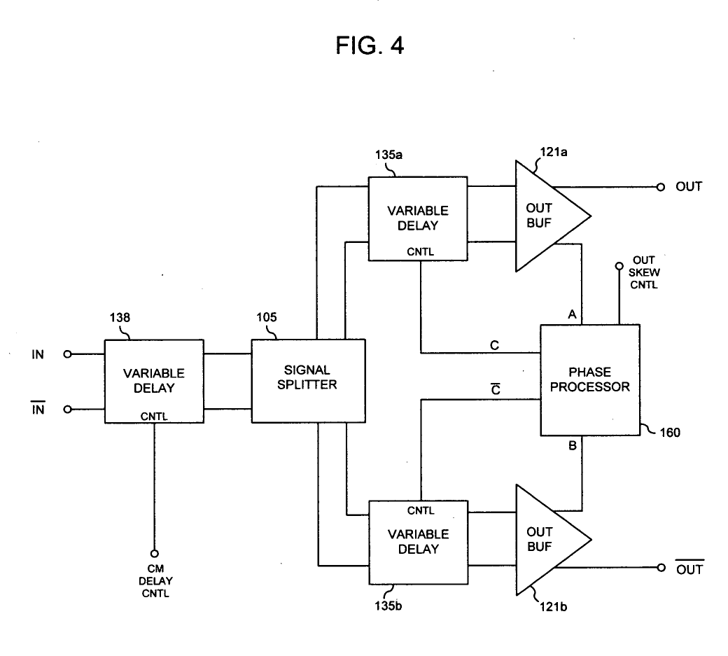

A modulator driver arrangement is presented in FIG. 4 as another embodiment of aspects of the present invention. The arrangement in FIG. 4 is similar to the arrangement in FIG. 3, except that an additional variable delay 138 has been added prior to the signal splitting function. The same components are denoted by the same reference numerals, and will not be explained again. In this arrangement, the variable delay 138 provides a common-mode delay function which delays the output drive signals equally, separate from the skew control loop. An external control signal (CM DELAY CNTL) is used to control the amount of common-mode delay. The addition of this functionality enables the alignment of the output drive signals from this modulator driver arrangement with other electrical signals in a system, such as, but not limited to, other driver output signals in a multiple electro-optical modulator scenario. Examples of multiple electro-optical modulator scenarios, not meant as a limitation, include carrier-suppressed return-to-zero (CS-RZ) modulation which typically requires two electro-optical modulators and two modulator drivers, as well as return-to-zero differential quadrature phase-shift-keying (RZ-DQPSK) modulation which typically requires three electro-optical modulators and three modulator drivers. The alignment of the electrical drive signals from multiple modulator drivers is typically a complex task; however, integrated functions within modulator driver architectures such as the aforementioned active skew control and common-mode variable delay help to reduce the complexity, size, and cost of transmission systems.

The modulator driver arrangements illustrated in FIGS. 3 and 4 can be modified according to aspects of the present invention. One example of such a modification, not meant as a limitation, is for the signal splitter 105 to further provide a limiting amplifier function. Another example of such a modification, not meant as a limitation, is for output buffers 121a, 121b to be comprised of distributed amplifiers or distributed current switches for high-speed operation. A further example of such a modification, not meant as a limitation, is for output buffers 121a, 121b to utilize active load circuitry for the reduction of power consumption. A yet further example of such a modification, not meant as a limitation, is for the architecture to eliminate one variable delay 135b and only use one variable delay 135a in the skew control loop. A variety of elements known to those skilled in the art, such as amplifiers, buffers, gain blocks, limiters, equalizers, resistors, capacitors, inductors, bias-T components, transmission lines, and the like, can be added to or deleted from the described arrangement, or the position of existing elements may be modified, without changing the basic form or spirit of the invention.

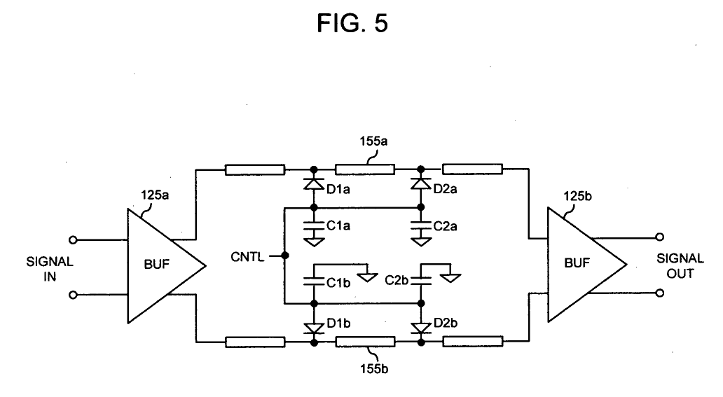

A circuit arrangement is illustrated in FIG. 5 as one embodiment of a variable delay 135a, 135b, 138 according to aspects of the present invention. In this arrangement, a differential input signal (SIGNAL IN) is coupled to a differential buffer 125a which provides a differential signal to a differential periodically loaded transmission line structure. The differential periodically loaded transmission line structure is comprised of transmission line segments 155a, 155b with the cathode side of varactor diodes D1a, D1b, D2a, D2b connected between said transmission line segments 115a, 155b. The anode side of varactor diodes D1a, D1b, D2a, D2b is connected to a control voltage potential (CNTL) that is bypassed by capacitors C1a, C1b, C2a, C2b. The control voltage (CNTL) is utilized to control the amount of reverse-bias voltage across the varactor diodes D1a, D1b, D2a, D2b, which controls the amount of periodic capacitive loading of the transmission lines, which in turn varies the amount of signal delay through the differential periodically loaded transmission line structure. At the end of the differential periodically loaded transmission line structure is a differential buffer 125b which is used to buffer the signals and provide a differential output signal (SIGNAL OUT). While there are a variety of arrangements that provide variable delay functionality, one advantage of this arrangement is that the circuitry illustrated is compatible with monolithic fabrication techniques.

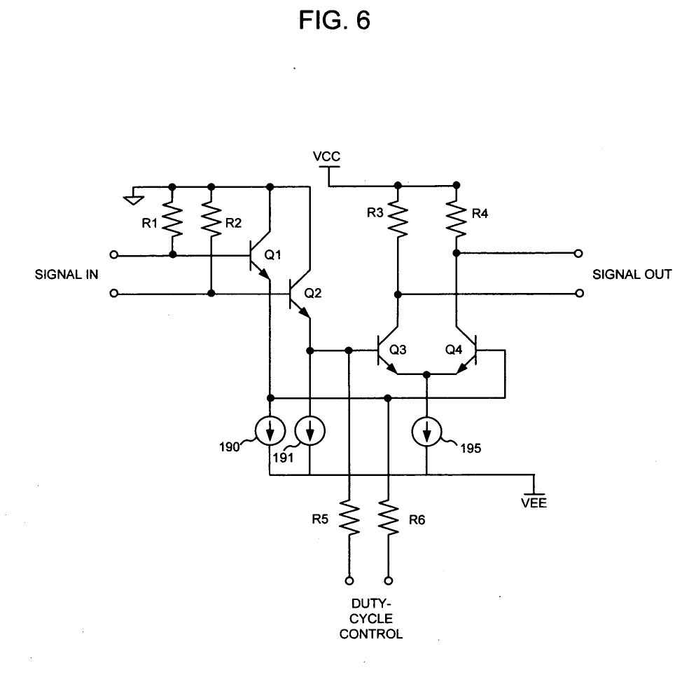

A circuit arrangement is illustrated in FIG. 6 as one embodiment of an output buffer 121a, 121b, and as one embodiment of a buffer 125a, 125b according to aspects of the present invention. In this arrangement, a differential input signal (SIGNAL IN) is coupled to transistors Q1, Q2 which form an emitter-follower configuration with current sources 190, 191. Resistors R1, R2 provide an input termination function. The output signals from the emitter-follower configuration are coupled to transistors Q3, Q4 which form a common-emitter configuration with current source 195. The differential output signals (SIGNAL OUT) are formed utilizing the load resistors R3, R4. A separate bias voltage VCC is provided for biasing load resistors R3, R4, which provides a positive bias voltage allowing an increase in the voltage swing headroom for the differential output signals. Current source 195 provides the output current which is steered between the differential signal output lines through application of a differential signal at the bases of emitter-coupled transistors Q3, Q4. Depending on the amplitude of this differential signal applied to the bases of emitter-coupled transistors Q3, Q4, the current from current source 195 is either partially steered between or fully switched between the differential signal output lines, providing the amount of limiting function required for the output signal. Also, the amplitude of the output differential signal is proportional to the current of the current source 195, which provides a simple method of output amplitude control through control of that current source. In addition, the incorporation of a small-valued series resistor within the current source 195 circuitry provides a simple method of monitoring the output signal amplitude, through monitoring of the voltage across the series resistor. Furthermore, resistors R5, R6 provide a simple method for adjusting the duty-cycle of the output signal through the application of an external differential voltage (DUTY-CYCLE CONTROL). Additionally, this configuration allows monolithic fabrication of essentially all of the circuitry of a modulator driver having an architecture such as illustrated in FIGS. 3 and 4, requiring only a minimum of external components for proper operation.

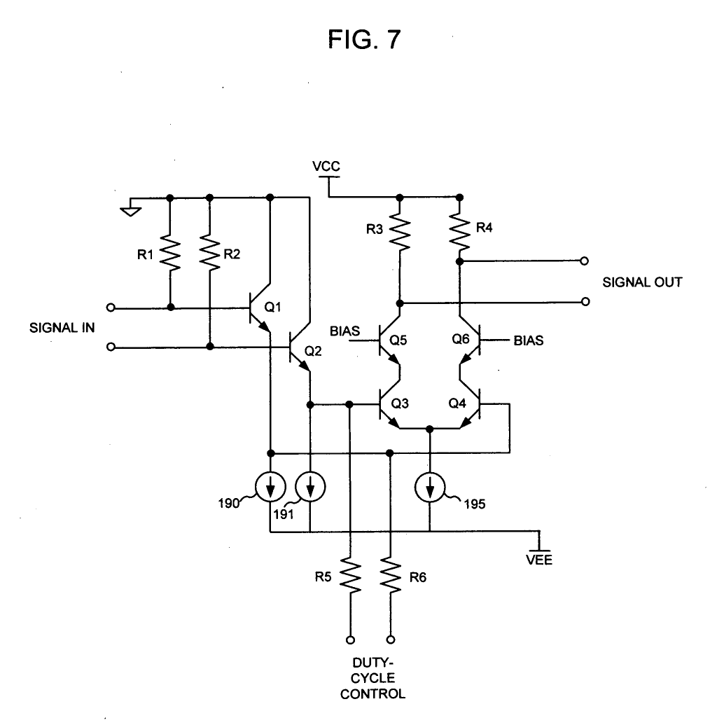

A circuit arrangement is illustrated in FIG. 7 as another embodiment of an output buffer 121a, 121b, and as another embodiment of a buffer 125a, 125b according to aspects of the present invention. The arrangement in FIG. 7 is similar to the arrangement in FIG. 6, except for the addition of transistors Q5, Q6 which form a cascode circuit arrangement. The same components are denoted by the same reference numerals, and will not be explained again. In this arrangement, the differential current signals from the collectors of Q3, Q4 are buffered by transistors Q5, Q6 which then form the differential output signals (SIGNAL OUT) utilizing the load resistors R3, R4. A biasing voltage (BIAS) is provided to the bases of transistors Q5, Q6 for proper operation. This configuration enhances the operating speed of the circuit through the reduction of the Miller capacitance effect. In addition, this configuration enhances the performance if a distributed output buffer configuration is utilized, through reduction of the loading of output artificial transmission lines. Furthermore, this configuration allows monolithic fabrication of essentially all of the circuitry of a modulator driver having an architecture such as illustrated in FIGS. 3 and 4, requiring only a minimum of external components for proper operation.

The circuit arrangements illustrated in FIGS. 6 and 7 can be modified according to aspects of the present invention. One example of such a modification, not meant as a limitation, is the use of multiple stages of circuitry for realization of the buffer functionality. Another example of such a modification, not meant as a limitation, is the use of other differential circuit topologies, such as differential Darlington amplifier circuitry, Cherry-Hooper amplifier circuitry, or any combination of these and the previously described circuits. A further example of such a modification, not meant as a limitation, is the use of CMOS, bi-CMOS, FET, HEMT, HBT, or DHBT transistors to realize the circuit functions rather than the illustrated bi-polar transistors. An additional example of such a modification, not meant as a limitation, is the use of a distributed amplifier or distributed current switch configuration for realization of the output buffers 121a, 121b. A yet further example of such a modification, not meant as a limitation, is the use of active load circuitry in the output buffers 121a, 121b in order to reduce the power dissipation in the modulator driver. A variety of elements known to those skilled in the art, such as amplifiers, buffers, gain blocks, equalizers, resistors, capacitors, inductors, transistors, transmission lines, and the like, can be added to or deleted from the described arrangement, or the position of existing elements may be modified, without changing the basic form or spirit of the invention.

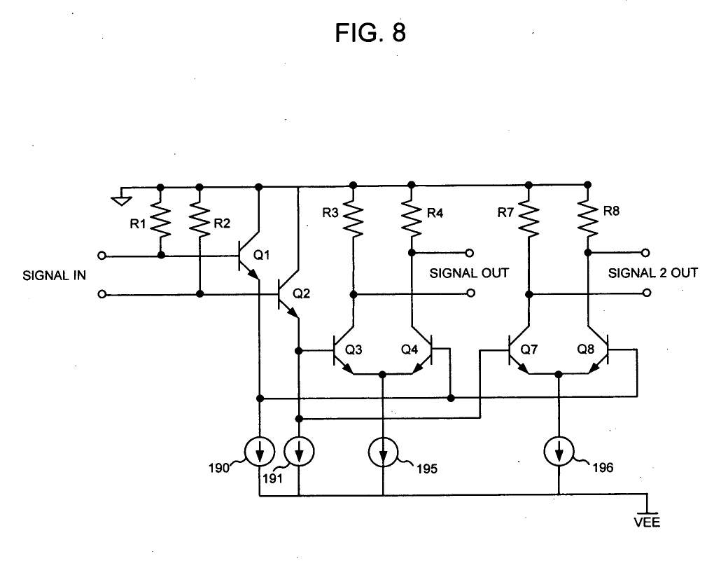

A circuit arrangement is illustrated in FIG. 8 as one embodiment of signal splitter 105 according to aspects of the present invention. The arrangement in FIG. 8 is similar to the arrangement in FIG. 6, except for the addition of a second common-emitter differential amplifier stage which provides a second differential output signal. The same components are denoted by the same reference numerals, and will not be explained again. In this arrangement, the differential output signals from emitter-follower transistors Q1, Q2 are also coupled to transistors Q7, Q8 which form a common-emitter configuration with current source 196. The differential output signals (SIGNAL 2 OUT) are formed utilizing the load resistors R7, R8. While the circuitry shown is biased to ground potential, it is understood that any or all of the circuitry shown can be biased to a positive supply voltage potential as required by a particular application. In addition, FIG. 8 illustrates one example of an active differential signal splitter circuit. Other active or passive, single-ended or differential signal splitter arrangements can be implemented by one skilled in the art without departing from the spirit of the present invention.

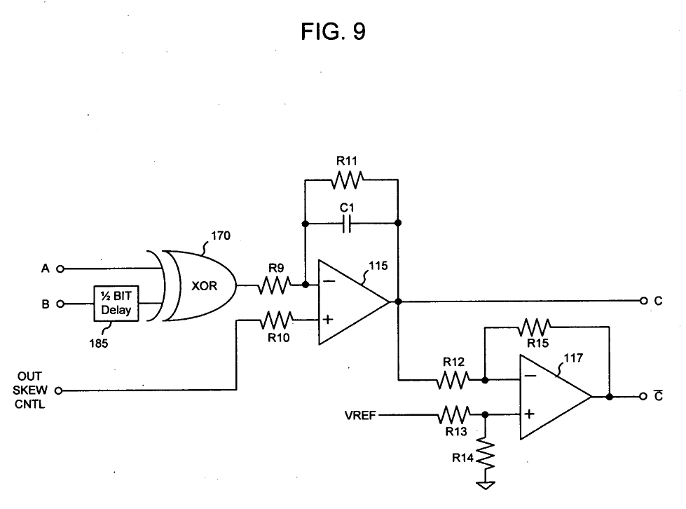

A circuit arrangement is illustrated in FIG. 9 as one embodiment of phase processor 160 according to aspects of the present invention. In this arrangement, an input signal A is coupled to one input of an exclusive-OR (XOR) logic gate 170, while a second input signal B is coupled to a second input of said exclusive-OR logic gate 170 after being delayed by ½ bit period by delay 185. The delay of signal B is performed to utilize a monotonic region of operation for the illustrated phase detection circuitry. The output of the exclusive-OR logic gate 170 is coupled to a comparator-integrator circuit comprising resistors R9, R10, R11, capacitor C1, and operational amplifier 115. An external control voltage (OUT SKEW CNTL) provides a reference to the comparator-integrator circuit which has the result of adjusting the set-point for the skew between signal A and signal B. The output signal (C) from the comparator-integrator circuit is a control signal that is used to control a variable delay in a skew control loop, such as variable delay 135a in FIG. 3. The output signal (C) is input to a circuit comprising resistors R12, R13, R14, R15, and operational amplifier 117 which generates an output signal that is complimentary to the output signal (C), with the appropriate selection of a reference voltage VREF. Together, the output signal (C) and its compliment are used to control the skew between signal A and signal B, and thus the output drive signals, by controlling variable delay circuits such as 135a and 135b shown in FIG. 3. The phase processing circuitry illustrated in FIG. 9 is meant as an example, not as a limitation. Other phase processor, phase detector, and control loop arrangements can be implemented by one skilled in the art without departing from the spirit of the present invention.

Although the preceding examples have illustrated multiple output modulator driver arrangements for use with a single electro-optical modulator, the concepts and methods described are extendable to multi-channel driver arrays, or multiple driver arrangements for use with multiple electro-optical modulators, without departing from the spirit of the present invention.

The preceding concepts, methods, and architectural elements described are meant to illustrate advantages and aspects of the present invention, not as a limitation. Different combinations of these concepts, methods, and architectural elements than that described in the preceding figures can be utilized by one of ordinary skill in the art without departing from the spirit of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A modulator driver apparatus for driving an electro-optical modulator in an optical communications system, comprising:
a first data amplifier configured to generate a first output data signal in response to a first input data signal;
a second data amplifier configured to generate a second output data signal in response to a second input data signal;
a phase processor having one input coupled to a signal derived from said first output data signal and another input coupled to a signal derived from said second output data signal, said phase processor generating a control signal derived at least in part from the relative position between data transitions occurring in said first output data signal and data transitions occurring in said second output data signal; and
a circuit for adjusting the relative delay between said first output data signal and said second output data signal in response to said control signal,
whereby the relative position between data transitions occurring in said first output data signal and data transitions occurring in said second output data signal is maintained at a set value.

2. The apparatus of claim 1, further comprising one or more additional output data signals.

3. The apparatus of claim 2, further comprising one or more additional inputs to, and one or more control signals generated by, said phase processor.

4. The apparatus of claim 3, further comprising additional means for adjusting the relative delay between the output data signals.

5. The apparatus of claim 1, wherein said first output data signal and said second output data signal are differential signals.

6. The apparatus of claim 1, wherein said first output data signal and said second output data signal are single-ended signals.

7. The apparatus of claim 1, wherein said first output data signal and said second output data signal carry separate information.

8. The apparatus of claim 1, wherein said first output data signal and said second output data signal are used for the purpose of encoding data in at least one of the amplitude or phase of light in an optical communications system.

9. The apparatus of claim 1, wherein said first output data signal and said second output data signal are DQPSK data signals.

10. The apparatus of claim 9, wherein said DQPSK signals are part of an RZ-DQPSK system.

11. The apparatus of claim 2, wherein said additional output data signals are DQPSK signals.

12. An apparatus for the modulation of light in an optical communications system, comprising:
an electro-optical modulator having a plurality of electrical inputs; and
a modulator driver providing a plurality of output signals connected to the electrical inputs of said electro-optical modulator,
said modulator driver comprising a phase processor having inputs coupled to signals derived from each of said output signals, said phase processor providing control of a circuit which adjusts the relative position between transitions occurring in at least one of said output signals and transitions occurring in at least one other of said output signals,
whereby the skew between said output signals provided to the electrical inputs of said electro-optical modulator is maintained at a set value.

13. The apparatus of claim 12, wherein said output signals are differential signals.

14. The apparatus of claim 12, wherein said output signals are single-ended signals.

15. The apparatus of claim 12, wherein said output signals carry separate information.

16. The apparatus of claim 12, wherein said output signals are DQPSK data signals.

17. The apparatus of claim 12, wherein said DQPSK signals are part of an RZ-DQPSK system.
